(19) United States
(12) Patent Application Publication
(10) Pub. No.: US 2007/0000320 A1
(43) Pub. Date: Jan. 4, 2007

(54) BIN LEVEL MONITOR

(76) Inventors: Mark H. Jaeger, Mapleton, MN (US); Michael W. Lundgreen, Fairmont, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/422,910

(22) Filed: Jun. 8, 2006

Related U.S. Application Data
(60) Provisional application No. 60/688,860, filed on Jun. 8, 2005.

(51) Int. Cl. G01F 23/26

(52) U.S. Cl. 73/304 C

(57) ABSTRACT

A bin or tank level monitoring system uses a capacitance-sensing device with at least one electrode vertically extending from near the top to near the bottom of the tank. Changes in the level of the material held in the tank causes the effective dielectric constant of the electrical capacitance between the electrode and for example, an adjacent conductive tank wall, to change continuously and proportionately. The change in the dielectric constant changes the actual capacitance between the electrode and the tank wall. Circuitry forming part of the system can measure this change in capacitance and use the measurement to provide an accurate indication of the level of material in the tank. A variety of configurations of the electrode or electrodes allows level detection for both conductive and non-conductive tanks and for different types of materials held in the tanks.

CROSS-REFERENCE TO RELATED APPLICATIONS

This is a regular application filed under 35 U.S.C. §111(a) claiming priority, under 35 U.S.C. §119(e)(1), of provisional application Ser. No. 60/688,860, previously filed Jun. 8, 2005 under 35 U.S.C. §111(b).

### FIELD OF THE INVENTION

The present invention relates generally to material level sensing and more particularly to a capacitive sensor for measuring the level of solids or liquids stored in containers.

### BACKGROUND OF THE INVENTION

Several means for measurement of the level of granular or liquid materials within a storage container or tank are known in the art. Some of the more common approaches in the industrial and agricultural industry include load cells to measure the entire weight of the container and contents and pressure sensitive switches that can detect the presence of the contained materials. The storage containers typically employed include steel or other metal containers such as a bin or tank.

The load cell solution provides very accurate results but also tend to include costly transducers and require complex mounting solutions. This results in labor-intensive installation procedures, leading to costly maintenance expenses. A number of the pressure sensitive switches are mounted internally along the entire height of the container. Such an arrangement provides a very coarse indication of material level in the tank. The precision of the measurement depends on the number of switches utilized.

Other methods of measuring the level of the container contents include an ultrasonic beam. These various other methods have had limited success.

Currently, one successful approach is to use the changes in capacitance between a first electrode such as a conductive wire or strip within the container, and another conductive electrode within the container. The second electrode may be the tank wall. Air has a dielectric constant different from that of almost any type of material that a container might hold. As the level in the tank increases, the average dielectric constant between the first and second electrodes changes. This change in average dielectric constant changes the capacitance between the first and second electrodes. The capacitance value across the electrodes can be measured and correlated with the level of the material in the container.

A need exists for a simple and inexpensive solution to measure the level of material stored in containers. The present invention provides a solution to these needs and other problems, and offers other advantages over the prior art.

### SUMMARY OF THE INVENTION

The present invention is generally directed to a bin or tank level monitoring solution. In a particular aspect of the present invention, there is provided a capacitance-sensing device utilizing as a first electrode, one or more cables, conductors, or probes extending substantially vertically from near the top to near the bottom of a container such as a metal tank. The measured capacity between the probes and the metal tank surface increases in a continuous and proportional manner as the level of the material in the container increases. This is due to the change in the dielectric constant between the tank wall and the probes.

In one embodiment, the system comprises an indicating device and one to four sensing circuits to allow up to four containers to be monitored. In one embodiment, the system is suited to be located in an outdoor environment. In one preferred embodiment, the indicating device contains a microprocessor that converts the capacitance sensed signal from the sensor to a scaled output signal used to illuminate one or more banks of LEDs (light emitting diodes) that indicate the level of material within a tank and which of a group of tanks is currently being displayed. In one preferred embodiment, the operator can manually select the tank level to be displayed at a given time, or allow the indicating device to continuously scan all connected tanks and alternately display the level results on the shared bank of LEDs.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a block diagram of the level sensor system.

FIG. 2 is a detailed schematic of the sensor circuit shown in FIG. 1.

FIG. 3 is a detailed schematic of the tank indicator circuit shown in FIG. 1.

FIG. 4 illustrates a tank having one preferred electrode configuration.

FIGS. 5 and 6 each show a tank having second and third preferred electrode configurations respectively.

FIGS. 7 and 8 show two preferred configurations for the cross section shape of electrodes.

### DETAILED DESCRIPTION OF THE INVENTION

Numerous level sense systems exist, however, the current systems available fail to provide low cost, simple solutions such as those driven by smaller businesses. The present invention will be described in preferred embodiments and is not intended to be limited as described.

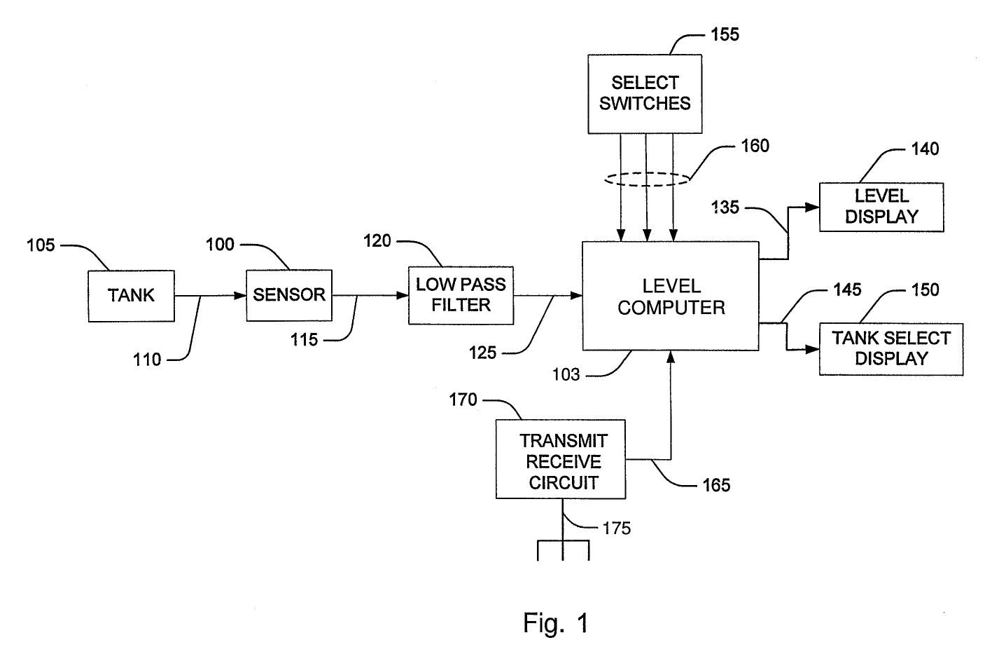

FIG. 1 is a block diagram of one embodiment of electronic circuitry that measures capacitance across first and second input terminals. The sensor circuit 100 is used to generate a level sense signal on a path 115 based upon a sensed capacitance level between a pair of conductors 110 attached to electrodes within a tank 105. The capacitance level between conductors 110 is determined by the level of material within the tank 105.

In one embodiment, as many as four tanks 105, four conductor pairs 110, four sensor circuits 100, four paths 115, and four low pass filters 120 may be present. The level sense signal on each path 115 generated by the sensor circuit 100 is a signal having periodic pulses. The frequency of these pulses changes inversely with the capacitance level across conductors 110. That is, the time between leading edges of adjacent pulses increases with increasing capacitance.

Each level sense signal is transmitted on a path 115 to an associated low pass filter 120 which provides a filtered level sense signal on an associated path 125. Each low pass filter 120 removes the noise in the level sense signal on path 115 to make it more suitable for subsequent processing by a level computer 103.

Level computer 103 receives the filtered level sense signal on each path 125, measures the period of the filtered level sense signal 125, and generates a display drive signal on a path 135 based on the level sense signal 125. Path 135 carries the display drive signal to a level display 140 that provides a visual indication based on the display drive signal on path 135.

The level computer 103 also generates a tank select signal on a path 145. In one preferred embodiment, the tank select signal on path 145 comprises four bits, each associated with one of the four tanks 105. A tank select display 150 receives the tank select signal on path 145. The tank select display 150 illuminates selected display features to provide a visual indication based upon the tank select signal on path 145 of which tank 105 level is currently displayed. In one preferred embodiment, the tank select display 150 comprises four light emitting diodes (LEDs), each representing selection of one of four tanks 105.

Select switches 155 provide a switch control signal on paths 160 to the level computer 103 which controls selection of a particular tank 105 and calibration of the level sense signal for the selected tank 105. In one preferred embodiment, the select switches 155 provide a switch control signal 160 to include selection of the one of the four tanks 105 providing the capacitance level. The identity of the selected tank 105 is displayed by the tank select display 140.

The level computer 103 generates a communication select signal which a transmit controller 170 receives on path 165. The communication select signal on path 165 indicates whether the level computer 103 is transmitting information to or receiving data from a host device such as a barn monitoring system. The transmit controller 170 generates a communication signal on path 175 for wireless communication.

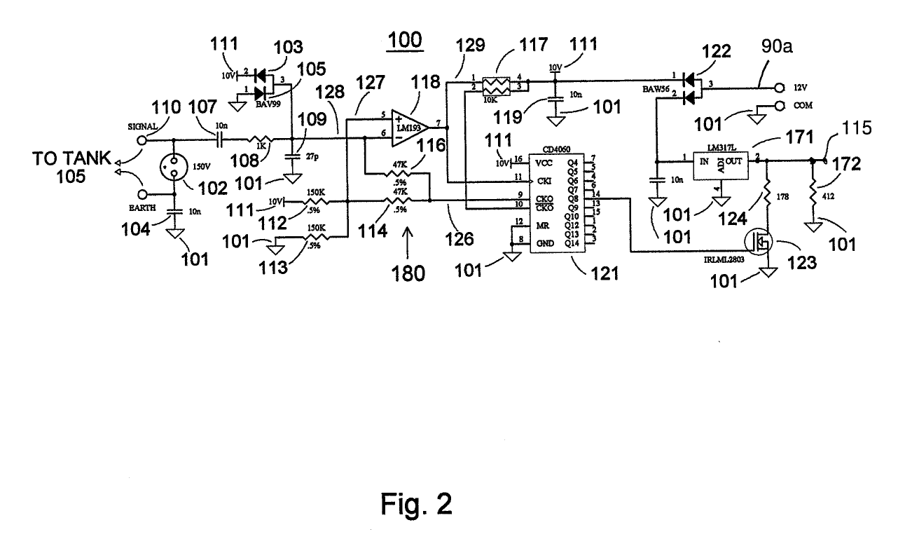

FIG. 2 is a detailed schematic diagram of the sensor circuit 100 shown in the block diagram of FIG. 1. Sensor circuit 100 generates the level sense signal on path 115 based on the value of the capacitance sensed across paths 110 and 101. Path 110 forms a first input terminal to circuit 100 and is connected to at least one electrode within tank 105. Tank 105 is grounded to complete the connection to a second input terminal 101 of circuit 100. Terminal 101 also serves as the ground bus for circuit 100. Alternatively, a common conductor may connect a tank 105 and path 101.

A gas tube voltage limiter 102 removes any high voltage noise such as static electricity from the level sense signal voltage on path 115. Capacitors 104 and 107 provide further protection between the level sense signal on path 115 and the tank 105 to prevent stray common-mode voltages from generating errors. The values of capacitors 104 and 107 are preferably large as compared to the capacitance level between paths 101 and 110. In one preferred embodiment, each capacitor 104 and 107 has a value around 10 nanofarads (ten percent tolerance).

Series resistor 108 provides current limiting and in one preferred embodiment may have a value of 1000 ohms (ten percent tolerance). To provide further static protection, diode 103 limits the sense signal to less than the 10 v. DC supply voltage at power terminal 111, and diode 105 limits the sense signal to signal ground 101. Thus, voltage spikes will not harm circuit 100. In one preferred embodiment the BAV99 small diode manufactured by Fairchild Semiconductor Corporation, South Portland, Me., may serve as diodes 103 and 105.

An amplifier 118; capacitor 109; the capacitance from tank 105 across input terminals 110 and 101; and resistors 116, 114, 112 and 113 comprise an oscillator circuit 180. Oscillator 180 design is tolerant of power voltage variations. The capacitance across input terminals 110 and 101 controls oscillator 180 frequency.

When the voltage value on the non-inverting+input terminal 127 of amplifier 118 goes positive relative to the voltage at—terminal 128, the output of amplifier 118 goes positive as well. A triangular or sawtooth waveform 128 is present on the inverting—input terminal of amplifier 118, and which is based on a square wave clock signal 126 generated by a frequency divider 121. One can consider that an internal jumper connects the CK1 and CK0 terminals of frequency divider 121.

Capacitor 109 is in parallel with the tank 105 capacitance. The voltage across tank 105 capacitance and capacitor 109 rises as current flows through resistors 112, 114, and 116 into tank 105 capacitance and capacitor 109. This capacitor voltage raises the terminal 128 voltage of amplifier 118 above the voltage at terminal 127. Amplifier 118 then pulls output terminal 129 to near 0 v. Resistors 114, 112 and 113 form a voltage divider that generates a resulting square wave threshold signal on terminal 127, which is sixty-one percent of the amplitude of the square wave clock signal at terminal 126. This determines the peak-to-peak voltage of the triangular waveform 128.

When the output terminal 129 of the amplifier 118 is in a high state near 10 v., the square wave clock signal at terminal 126 is also high. When the triangular waveform on terminal 128 reaches the level of the square wave threshold signal voltage on terminal 127, the output terminal 129 of amplifier 118 switches to a low state. This process of switching repeats which generates a signal at terminal 129 having a frequency based upon the sum of the tank 105 capacitance and the value of capacitor 109.

In one preferred embodiment, amplifier 118 is preferably a low power, low offset voltage comparator similar to the LM 193, manufactured by National Semiconductor Corporation, Santa Clara, Calif. In that preferred embodiment, capacitor 109 is selected to be 27 picofarads (ten percent tolerance), resistors 114 and 116 are selected to be 47 kilohms (one half percent tolerance), and resistors 112 and 113 are selected to be 150 kilohms (one half percent tolerance). The frequency divider 121 may be a fourteen stage ripple divider oscillator similar to the CD4060, manufactured by Texas Instruments, Dallas, Tex.

The frequency divider 121 divides the frequency of the signal at the output of amplifier 118 by a factor of 256 and transmits the resulting low frequency signal to the gate of a transistor 123. Each time the transistor 123 is switched on, current flows through transistor 123 and resistor 124. Voltage regulator 171, which may be similar to model LM317L available from Fairchild Semiconductor, provides a constant 1.25 v. to resistors 124 and 172. The value of resistor 172 may be 412 ohms, allowing a bias current of 3.0 ma. The value of resistor 124 is 178 ohms. When transistor 123 switches on, the circuit draws an additional 7.0 ma. but voltage at path 115 remains essentially constant

Thus, the edges of the waveform provided by frequency divider 121 cause changes in current flow only on path 115. Level computer 103 will sense this change in current when determining the frequency of the signal output from frequency divider 121. Converting voltage changes to current changes reduces noise on path 115 which may be located at some distance from the associated low pass filter 120.

In one preferred embodiment the transistor 123 is preferably a low on-resistance N-channel MOSFET similar to the IRLML2803, manufactured by International Rectifier, El Segundo, Calif. In one preferred embodiment, the resistor 124 value is 1.69 kilohms (one percent tolerance).

Terminal 90a receives 12 v. DC from the low pass filters 120. Diode network 122 drops the voltage at power terminal 111 to about 10 v. and capacitor 119 further filters ripple from the DC voltage at terminal 111. The voltage at power terminal 111 provides power voltage for amplifier 118 and divider 121. Resistor network 117 provides pull-up voltages for amplifier 118 and the NOT CKO terminal of voltage divider 121.

The design for sensor circuit 100 allows connection to the system with only two wires if ground is a reliable third connection: power connection at terminal 90a and signal connection at path 115. If ground is not reliable, then a neutral or ground wire must connect to terminals 101.

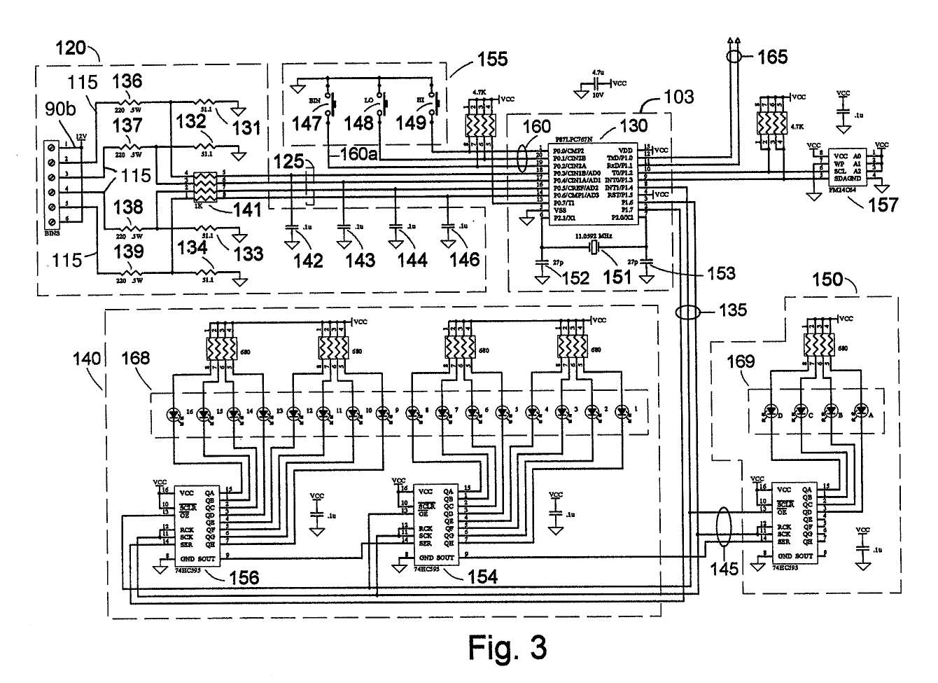

FIG. 3 is a schematic diagram of one preferred embodiment for displaying the level of material stored in up to four tanks 105. FIG. 3 shows low pass filters 120, the level computer 103, and the display and control elements shown in the block diagram of FIG. 1. The level computer 103 senses the spacing between adjacent pulses in each level sense signal on a path 115 and passing through a low pass filter 120 from a sensor circuit 100.

This embodiment shows four low pass filters 120 in FIG. 3, each receiving a sensor signal on an associated signal path 115 from an associated sensor circuit 100. A first low pass filter 120 comprises resistors 131 and 136, one of the resistors in network 141, and capacitor 142. A second low pass filter 120 comprises resistors 132 and 137, one of the resistors in network 141, and capacitor 143. A third low pass filter 120 comprises resistors 133 and 138, one of the resistors in network 141, and capacitor 144. A fourth low pass filter 120 comprises resistors 134 and 139, one of the resistors in network 141, and capacitor 144.

Resistors 131-134 convert the current signal from the respective sensor circuit 100 to a filtered sensor voltage. A microprocessor 130 receives these sensor voltages and measures the time between similar edges of adjacent pulses. Resistors 136-139 provide current limiting if faults in connections arise.

The combination of the resistors in network 141 and capacitors 142, 143, 144, and 146 determine the cutoff frequency of each low pass filter 120. Each low pass filter 120 generates a filtered level sense signal on one of the paths 125 that removes the noise of the level sense signal on the corresponding path 115 to make it more suitable for the level computer 103.

In one preferred embodiment, resistors 131, 132, 133, and 134 each have values of 51.1 ohms (10% 0.5 W.), and resistors 136-139 each have values of 220 ohms (10% 0.5 W.). This preferred embodiment's resistor network 141 is selected to be 1000 ohms (10%) each and capacitors 142, 143, 144, and 146 have 100 nanofarad values (10%).

For convenience, a pair of conductors may carry both power and signal between the low pass filters 120 and the sensor circuits 100. The power connection is between conductor 90b and each terminal 90a in a sensor circuit 100. In some circumstances the installer may wish to provide a third, neutral connection between ground terminals 101 in the low pass filters 120 and the sensor circuits 100.

The microprocessor 130 forms a major part of level computer 103. An important purpose for microprocessor 130 is to measure the period of the filtered level sense signals provided on paths 115. A crystal oscillator 151 with capacitors 152 and 153 provides a precise time standard for measuring the time between similar adjacent voltage transitions in the sensor signal.

The microprocessor 130 generates a display drive signal carried on paths 135. The display drive signal is transmitted to the level display 140 which comprises a first bank of LEDs 168 driven by serial shift registers 154 and 156. The first bank of LEDs 168 is representative of the level in a given tank (all LEDs lit represent a full tank) based upon the selection of a particular tank 105.

Microprocessor 130 generates a tank select signal carried on paths 145. In one preferred embodiment, the tank select signal comprises four bits, each representative of the capacitance level available on one of four connections 110 to one of four tanks 105. Each tank select signal is transmitted to a tank select display 150 comprising a second bank of four LEDs 169. Each LED in the second bank of LEDs 169, indicates selection of one of four tanks 105.

The select switches 155 provide control signals on paths 160 to the microprocessor 130 which controls the calibration of the level sense signal 115, as described above. The select switch bank 155 consists of the tank select switch 147, a low level calibration switch 148 and a high level calibration button 149. If switch 147 is not depressed, the default control of level display 140 is timed to cycle among each tank 105 connected to the system for a period of two seconds each, as controlled by microprocessor 130. During the time that display 150 indicates a particular tank 105 is temporarily selected, pressing switch 147 permanently selects that particular tank 105 until switch 147 is pressed again.

Calibration of the system involves manipulation of switches 147 and 148 while each of the tanks 105 are empty, and manipulation of switches 147 and 149 while each of the tanks 105 are filled. For each tank 105 when it is empty, low level calibration occurs when operator depresses and holds the tank select button 147 to select the desired tank 105 while at the same time pressing the low level calibration button 148. For each tank 105 when it is full, high level calibration occurs when the operator depresses and holds the tank select button 147 to select the desired tank 105 while at the same time pressing the high level calibration button 149.

In one preferred embodiment the microprocessor 130 is preferably a processor similar to P87LPC767N, the crystal oscillator 151 is selected to be 11.0592 megahertz, and capacitors 152 and 153 are selected to be 27 picofarads (ten percent tolerance). The level display 140 may comprise a first bank of sixteen LEDs 168. Select switches 155 are preferably normally open push button switches.

A communication select signal 165 is generated by the microprocessor 130 which is transmitted to the transmit controller 170. The communication select signal 165 determines whether the microprocessor 130 is transmitting information to or receiving data from the host device.

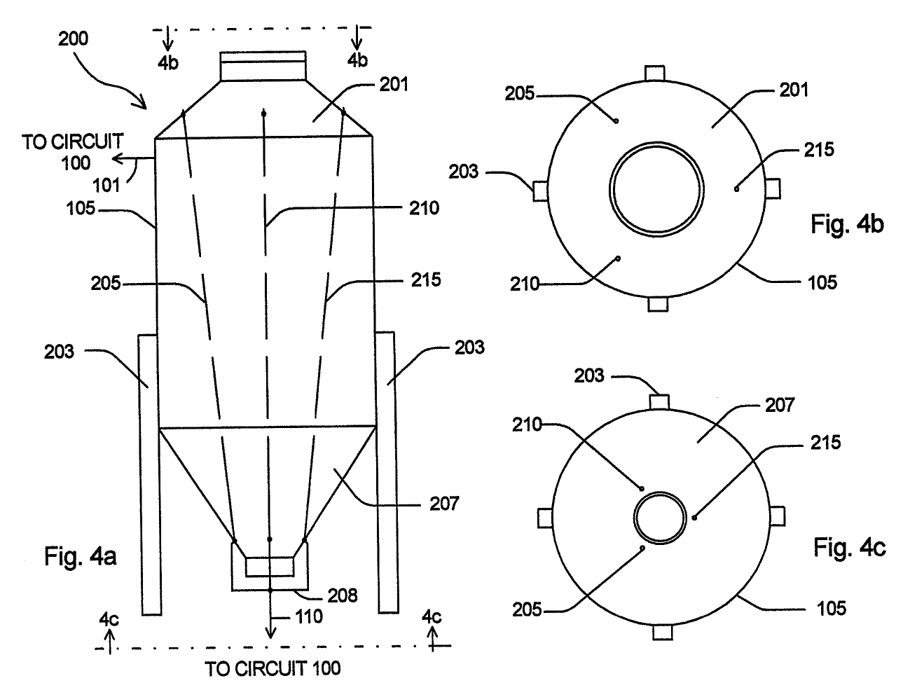

FIG. 4 illustrates a tank system 200 wherein cables 205, 210, and 215 collectively comprise a first electrode of a tank capacitance to be connected to terminal 110 of a sensor circuit 100. The wall of tank 105 is conductive and forms the second electrode of the tank 105 capacitance. As the level of material filling tank 105 changes, the capacitance between cables 205, 210, and 215 on the one hand and the wall of tank 105 also changes because the effective dielectric constant changes for the tank 105 capacitance.

The cables 205, 210 and 215 are strung from the top surface 201 to the bottom surface 207 with strain relief. The cables may comprise aircraft quality cable with plastic insulation on the exterior. However, in certain installations, non-insulating cable may be adequate.

One type of material commonly held in a tank 105 is animal feed. Experience shows that feed stored in tanks may drop significantly faster in the center of the tank as compared to the exterior surface, resulting in an upper surface of the material that is not level. This is known as tunneling and increasing the number of cables reduces this potential level error. As shown in FIG. 4, cables 205, 210, and 215 form acute angles with at least a portion of the tank 105 wall. This angled configuration compensates to some extent for situations where the surface of the material is not level.

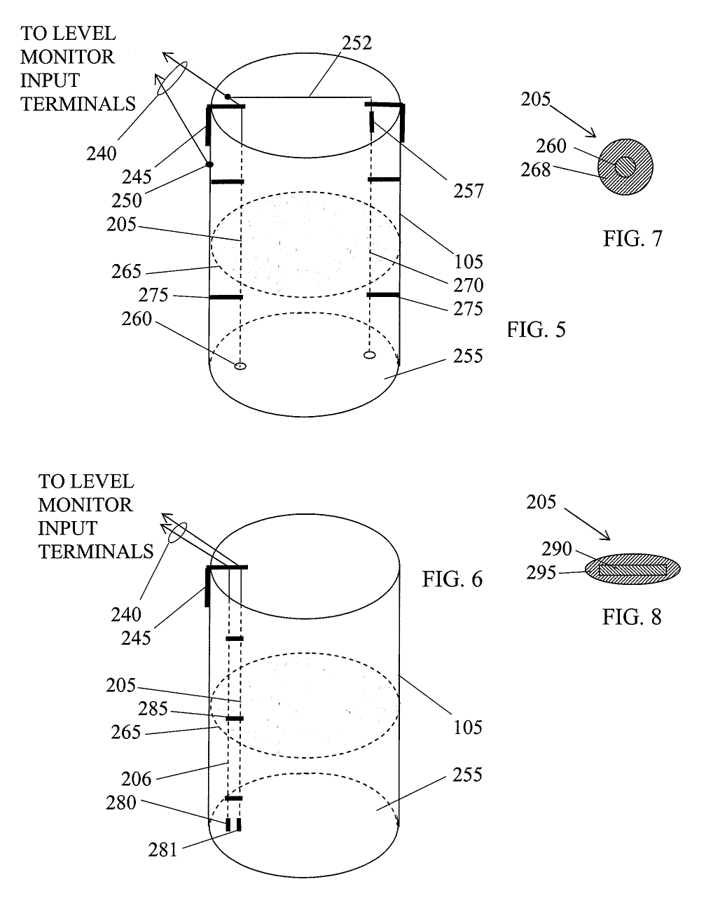

FIGS. 5 and 6 show alternative embodiments for electrode configuration. Tank 105 has a bottom 255 above which the level or height of material can vary. In FIGS. 5 and 6, the level of the material held in tank 105 is shown at 265.

In FIG. 5, a pair of brackets 245 attached to a conducting wall of tank 105 extends over the top of tank 105. The tank top 205 of FIGS. 4a and 4b may be considered to comprise brackets 245. Electrodes 205 and 270 extend vertically downwards from cantilevered ends of brackets 245 and dead end on the bottom 255. Standoffs 275 hold electrodes 205 and 270 at a substantially constant spacing from the wall of tank 205. One or both of electrodes 205 and 270 may have a tensioner 257, which may be a spring or other elastic device that does not interfere with the electrical conductivity of electrodes 205 and 270. Tensioner 257 keeps electrode 270 taut to further promote constant spacing of electrode 270 from the wall of tank 105.

Electrodes 270 are insulated from tank 105 at brackets 245 and bottom 255, and from standoffs 275 as well if standoffs 275 are conductive. A jumper 252 electrically connects electrodes 205 and 270. Conductors 240 connect electrodes 205 and 270 and tank 105 to a sensor circuit 100. Standoffs 275 maintain electrodes 270 at a constant spacing from the wall of tank 105, thereby providing more linear response to changes in level 265 by the capacitance between electrodes 205 and 270 as one plate of the capacitor and the wall of tank 105 as the other capacitor plate.

FIG. 6 shows another embodiment for the electrode configuration within a tank 105. Electrodes 205 and 206 are suspended from a bracket at the top of tank 105. Electrodes 205 and 206 hang down and are maintained relatively taut by weights 280 and 281 attached to the bottom ends of electrodes 205 and 206. Insulated spacers 285 maintain a constant spacing between electrodes 205 and 206. Conductors 240 connect to input terminals 110 and 101.

FIGS. 7 and 8 show cross sections of electrodes with interior conductors 260 and 290 respectively, and exterior insulating jackets 268 and 295 respectively. It is also possible to suspend a single electrode 205 from bracket 245 or a tank top 201 and with or without a weight for tensioning, where the wall of tank 205 is conductive.

One should understand that the numerous characteristics and advantages of various embodiments of the present invention as set forth above are illustrative. This is true especially in matters of structure and arrangement of parts within the principles of the present invention to the full extent indicated by the broad general meaning of the term in which the appended claims are expressed. For example, the particular components such as operational amplifiers and comparators may vary by manufacturer, having differing design tolerances, pin-out and packaging. Additionally, the discrete components such as resistors, diodes and capacitors may have a wide range of operating parameters which will affect the results in varying degrees. The particular components may be selected depending on the particular application for the level sense control circuit while maintaining substantially the same functionality without departing from the scope and spirit of the invention. For example, it can be appreciated by those familiar with the art, that the number of tanks to be monitored may vary from installation to installation. Therefore, alternative embodiments may include a different microprocessor or multiple microprocessors to manage the information.

In addition, although the preferred embodiment described herein is directed to a level sense circuit for liquid or granular storage systems, it will be appreciated by those skilled in the art that the teachings of the present invention can be applied to other systems, like gas storage systems in which the dielectric value changes measurably without departing from the scope and spirit of the present invention.

As suggested in connection with FIG. 6, the system can be configured for use in a non-conductive container, bin or tank that utilizes the concepts described herein by adding additional probes or cables and connecting them to the other side of the bin sensing circuit 100 in place the connection to the tank 105.

What is claimed is:

1. A an electrode arrangement for use with a system for measuring the depth of a flowable material within a tank having a top and a bottom, the material comprising at least one of a solid and a liquid, said system including a sensor circuit having first and second input terminals, and providing a tank capacitance signal indicating the capacitance sensed between the first and second input terminals; said electrode arrangement comprising:
a) a first conductive electrode extending generally vertically within the tank from near the tank top to near the tank bottom, said first electrode for electrical connection to the sensor circuit's first input terminal; and
b) a second electrode comprising at least one of a conductive tank wall and a conductive second electrode extending generally vertically within the tank from near the top to near the bottom, said second electrode for electrical connection to the sensor circuit's second input terminal and insulated from the first electrode, said second electrode positioned to allow portions of the material to occupy space between the first and second electrodes along at least a portion of the electrodes' lengths.

2. The electrode arrangement of claim 1, wherein the first electrode is a flexible cable covered with electrical insulation.

3. The electrode arrangement of claim 2, wherein the second electrode has a substantially constant spacing from the first electrode.

4. The electrode arrangement of claim 2, wherein the tank includes a bracket extending over the tank interior, and wherein the first electrode is suspended from the bracket.

5. The electrode arrangement of claim 4, wherein the second electrode comprises a second electrode suspended from the bracket in spaced arrangement with the first electrode.

6. The electrode arrangement of claim 1, wherein the wherein the first electrode comprises a conductive cable connected to a first insulator at the top part of the tank at a first end, and to a second insulator at the bottom part of the tank at a second end.

7. The electrode arrangement of claim 1, wherein the tank wall comprises the second electrode, and including a plurality of standoffs supporting the second electrode at a predetermined spacing from the tank wall along the electrode length.

8. The electrode arrangement of claim 1, wherein the first electrode comprises a flexible cable.

9. The electrode arrangement of claim 1, wherein the first electrode comprises a conductive strip.

10. The electrode arrangement of claim 9, wherein the second electrode comprises the tank wall.

11. The electrode arrangement of claim 10, including standoffs supporting the first electrode at a predetermined spacing from the tank wall.

12. The electrode arrangement of claim 10, including standoffs supporting the first electrode at a constant predetermined spacing from the tank wall.

13. The electrode arrangement of claim 10 for use in a tank holding conductive flowable material, including an insulating cover on the first electrode.

14. The electrode arrangement of claim 10, including insulating standoffs supporting the first electrode at a predetermined spacing from the tank wall.

15. The electrode arrangement of claim 10, including insulating standoffs supporting the first electrode at a constant predetermined spacing from the tank wall.

16. The electrode arrangement of claim 1, including a plurality of first electrodes.

17. The electrode arrangement of claim 1 wherein the first electrode is a flexible cable hanging within the tank.

18. The electrode arrangement of claim 1 wherein the first electrode is a flexible cable hanging within the tank from a bracket near the top of the tank, and supporting a freely suspended weight near the tank bottom.

19. The electrode arrangement of claim 1, wherein at least a portion of the tank wall is conductive, and wherein the first electrode forms an acute angle with at least a portion of the conductive tank wall portion.
